(19) United States
(12) Patent Application Publication
(10) Pub. No.: US 2006/0034568 A1
(43) Pub. Date: Feb. 16, 2006

(54) Integrated optics filtering component comprising an optical cladding and method for making same

(75) Inventor: Christophe Martinez, Grenoble (FR)

Correspondence Address: PILLSBURY WINTHROP SHAW PITTMAN, LLP, P.O. BOX 10500, MCLEAN, VA, 22102, US

(73) Assignee: Teem Photonics, Meylan (FR)

(21) Appl. No.: 10/538,138

(22) PCT Filed: Dec. 15, 2003
(86) PCT No.: PCT/FR03/50175

§ 371 Date: Jun. 9, 2005

(30) Foreign Application Priority Data
Dec. 16, 2002 (FR) 0215919

(51) Int. Cl. G02B 6/34; G02B 6/26; G02B 6/10; G02B 6/42

(52) U.S. Cl. 385/37; 385/129; 385/130; 385/132; 385/43; 385/39

(57) ABSTRACT

The invention relates to an integrated optics filtering component comprising in a substrate (10) at least one filtering unit comprising an optical guide core (11), an optical cladding (13) independent of the core and at least two elementary zones of interaction in series (Z1, Z2, Z3), in which each elementary zone of interaction has at least one structural parameter that is different from that or those adjacent to it, where each elementary zone of interaction is defined by a zone of the substrate comprising an elementary grating (R1, R2, R3), at least one portion of the cladding called the elementary cladding (G1, G2, G3) surrounding at least one portion of the core, called the elementary core, where the refractive index of each elementary cladding is different from the refractive index of the substrate and lower than the refractive index of the core at least in the part of the elementary cladding next to the elementary core, and the different elementary gratings of a filtering unit forming a grating.

### TECHNICAL FIELD

This invention relates to an integrated optics filtering component comprising optical cladding optical cladding as well as its fabrication method.

The invention has applications in all fields, which require spectral filtering and in particular evolved spectral response filtering. It is used in particular in the creation of gain flatteners for optical amplifiers used for example in the field of telecommunications or even creating linear response filters whose wave length is on a defined spectral band for spectral recognition, especially for measuring spectral offsets with power variation for example in the field of sensors.

Generally speaking, the invention applies particularly well to all systems that require the use of spectral response filtering suited to a specific requirement, this type of filtering generally requiring the development of an evolved filter.

### STATE OF THE PRIOR ART

There are currently several evolved filtering solutions using guided optics. These solutions traditionally include three major families of components:
Diffraction gratings (Bragg gratings, long period gratings, etc.),
Thin layer filters with fibres,
Guided optics interference filters.

The invention relates to the first of these families.

The general principle of evolved filtering using diffraction gratings consists of forming a filter with an evolved form by sampled or distributed modification of the grating parameters. The grating may then be considered as a succession of elementary gratings.

In this way in FIG. 1, we can see the trace of a modulation Δn of the refractive index of the core of a fibre, obtained in a direction z of propagation of a light wave in the core, for the elementary gratings R1 to R4 positioned in series in the said direction z. The unit forms a complete evolved spectral response grating. This index modulation is generally obtained when the grating is created, by photo-inscription in the fibre core.

The purpose of the sampled modification of the grating parameters is to change the characteristics, mainly the wavelength and the coupling efficiency, of the elementary gratings.

Currently, the long period gratings (or LPG) are used in optical fibres to create in particular flattening filters.

Documents (1) and (2) by the same author, whose references are provided at the end of the description, illustrate this type of filter, in particular the document (2) describes the creation of a GFF by the association of several gratings in fibres.

Document (3), whose reference is also provided at the end of the description, describes in more detail the creation of a GFF by adjusting the parameters of the gratings. The author's objective is to optimise the creation of the gratings by limiting the parameters. To do this, the author chose to modify the gratings phase by introducing a controlled space between the gratings in order to create an offset between the gratings. The period of the gratings may then be uniform or may vary depending on sampling or continuous distribution.

By way of example, FIG. 2 shows diagrammatically in cross section a grating filtering component, created from a fibre. This component comprises an optical fibre 1 shown partially, composed of a core 5 in which a grating an optical cladding 7 are formed all around the core. The grating is formed of 3 elementary gratings R2, R1 and R3 in series, which respectively induce a zone of interaction between the core and the cladding next to the corresponding grating, permitting a light wave of the core to be coupled to the cladding or vice versa.

FIG. 3a shows the distribution of the light energy of a light wave E introduced in the core 5 of the fibre 1 respectively for three central wavelengths λ₁, λ₂, λ₃ of spectral bands of the wave. FIG. 3b shows the distribution of the light energy of a light wave S recovered at the output of the core 5 of the fibre 1 for these three central wave lengths λ₁, λ₂, λ₃.

By spectral band it is meant a band with a set of wave lengths with whose central wave length and band width are determined, given that a light wave can comprise one or more several spectral bands.

In this way, the light wave E introduced into the core 5 of the fibre 1 is transported by it to the grating R2. The grating then permits the coupling for spectral band of central wavelength λ₂, all or part of the guided mode de the wave, to one or more cladding modes spreading in the optical cladding 7, in the same direction as the guided mode. The coupled modes are shown symbolically by arrows.

The part that is not coupled by the grating R2 of the initial wave continues to spread in the core to the grating R1. The latter then permits the coupling for the spectral band of central wave length λ₁, all or part of the guided mode of the part not coupled by the grating R2 of the initial wave, to one or more cladding modes. The part that is not coupled by the gratings R2 and R1 of the initial wave continues to spread in the core to the grating R3. The latter then permits the coupling for the spectral band of central wavelength λ₁, all or part of the guided mode of the part not coupled by the gratings R2 and R1, to one or more cladding modes. After these different couplings, the light wave S corresponding to the part of the wave E that is not coupled by the gratings R2, R1, R3, is recovered at the output of the grating R3.

In this example, the parameters various elementary gratings R2, R1 and R3, are modified to transform the light wave E which has amplitudes that differ according to the wave lengths λ₁, λ₂, λ₃ (see FIG. 3a) in a light wave S that has identical amplitudes to these wave lengths (see FIG. 3b).

In the specific case of long period gratings, the coupling by an elementary grating between the various modes takes place for wave lengths λⱼ determined by the following known relationship:
λⱼ=Λ×(n₀−nⱼ) (1)
where:
   n₀ is the effective index of the guided mode 0 in the core,
   nⱼ is the effective index of the cladding mode number j,
   λⱼ is the resonance wave length for the coupling in mode j,
   Λ is the period of the elementary grating.

This coupling results in a transfer of energy between the guided mode of the core and the one or more cladding modes for the wave lengths λⱼ. The energy coupled in the cladding modes is then guided in the cladding generally with losses.

The modification of λⱼ therefore includes the modification of the parameters of Λ and/or of the distribution of the effective indices of the different modes.

The efficiency of the coupling between the modes depends on the length of the grating and the coupling coefficient K_{0J} between the modes 0 and j. This coefficient is provided by the spatial recovery integral of the modes 0 and j, weighted by the index profile induced by the grating. In this way we have a relationship of the type:
K_{0J}∝∫∫ξ₀.ξ_{J}*.n.ds (2)
where:
   ξ₀ and ξⱼ are the transversal profiles of the modes 0 and j and ξⱼ* is the complex conjugate of ξⱼ,
   Δn is the amplitude of the effective index modulation induced by the grating in a plane perpendicular to the direction de propagation of the wave,
   ds is an integration element in a plane perpendicular to the axis of propagation of the wave,

The modification of K₀ⱼ is obtained by varying the profile of the modes and/or the index profile induced by the grating, in other words by varying the opto-geometrical characteristics of the cladding and/or of the core (dimensions, index level, etc.) and/or the characteristics of the grating (Δn, position of the grating with respect to the core and the cladding, etc.).

Generally speaking in optical fibres to modify the characteristics of the zones of interaction, the following parameters can be modified:
the length L of the grating, P1 its period Λ,
Δn the amplitude of the effective index modulation induced by the grating,
n_{co} the index of the fibre core,
φ the phase of the grating.

The large number of parameters makes the creation of an evolved filter as previously described somewhat difficult. One of the difficulties is firstly the qualification and the quantification of the parameters of the elementary gratings, which permit the desired evolved spectral form to be obtained. This difficulty is theoretical. A second difficulty is the practical creation of the elementary gratings whose parameters are adjusted in this way with the greatest precision possible.

These two problems are linked as the application of a creation process demands the choice and elimination of some parameters.

Furthermore, the core of the fibre depends on the optical cladding in which it is formed and the cladding has a refractive index lower than that of the core to permit the propagation of a light wave in the core. The core cannot exist without the optical cladding, this dependence limits the possibilities of modifying the parameters of the gratings and the design solutions for the design, architecture and integration of the gratings in complex systems.

The creation of the evolved filter described for the optical fibres can be transposed to integrated optics. One example of a filter using a grating in an integrated optics structure is described in the patent U.S. Pat. No. 5,949,934. In this patent, we can see the use of an optical cladding on either side of a grating formed in the core of an integrated optics guide, this unit being located on a substrate. This cladding is created by the superposition of layers between which the core is sandwiched. In this patent, the core is still dependent on the cladding as it cannot exist without the layers between which it is positioned. The cladding described in this patent permits the induction of both the cladding modes and the creation of a support for the core guide. We therefore have the same parameter problems in integrated optics as in fibres.

### DESCRIPTION OF THE INVENTION

The purpose of this invention is to propose an integrated optics filtering component, comprising at least an optical cladding as well as its creation process, the use of a cladding of the invention permitting the parameter modification difficulties of the prior art to be overcome by offering more flexibility in the modification of the parameters. This filtering component may be an evolved filter.

One purpose of the invention is to propose a filtering component comprising at least one optical cladding that is independent of the guide core to which it is associated. By independent of the core and the cladding, it is meant that they can exist in a substrate independently of one another. In other words, the core can exist without the cladding and the cladding can exist without the core.

One purpose of the invention is also to create a filtering component capable of modifying in particular at least one characteristic of the mode(s) spreading in the core.

The characteristics of the mode(s) spreading in the core may be in particular the effective index, the size of the mode and/or the phase.

More precisely, the integrated optics filtering component of the invention comprises in a substrate at least one filtering unit comprising an optical guide core, an optical cladding independent of the core and at least two elementary zones of in series, each elementary zone of interaction with at least one structural parameter different from that or those to which it is adjacent, each elementary zone of interaction being defined by a zone of the substrate comprising an elementary coupling grating between the guide core and the optical cladding, at least one portion of the cladding called the elementary cladding surrounding at least one portion of the core, called the elementary core, the refractive index of each elementary cladding is different from the refractive index of the substrate and lower than the refractive index of the core at least in the part of the elementary cladding next to the elementary core, the various different elementary gratings of a filtering unit forming a grating.

By elementary grating, it is meant a grating whose structural parameters are constant.

The elementary claddings of a cladding may be different or identical, contiguous or separate.

By surrounding it is meant that the fundamental mode profile of the guide core has a maximum that is included in the index profile of the cladding. In this way, the profile of the fundamental mode of the core may be completely or partially included in the index profile of the cladding which results at structural level in a core that is situated anywhere at all in the cladding including at its edge in which case the core may be partially outside of the cladding.

By adjacent it is meant that the zones of interaction may be contiguous or separate

In the invention, the cladding and the core exist independently from one another in the substrate, which is not the case in the prior art. This independence permits more flexibility in the creation of the filtering component. In particular, the core can no longer be situated in the cladding outside of the zones of interaction but solely in the substrate which permits the optical isolation of the core. In this way the cladding only influences the propagation of a light wave in the associated guide core associated in the part surrounding the core and the cladding can guide or transport light waves independently of the core.

The cladding of the invention is created artificially in the substrate, at least in the zones of interaction and independently of the core and the substrate.

In general, we will call artificial cladding this type of cladding and elementary grating with artificial, a zone of interaction. The set of elementary gratings with artificial cladding, which is to say the set of zones of interaction, forming an artificial cladding grating.

The substrate may of course be made using a single material or by the superposition of several layers of material. In this case, the refractive index of the cladding is different from the refractive index of the substrate at least in the layers next to the cladding.

Advantageously, each elementary cladding has a refractive index higher than that of the substrate.

In the invention, the guide may be a planar guide when the light is confined in a plane containing the direction of propagation of the light or a microguide, when the light is confined in two directions transversal to the direction of propagation of the light.

Furthermore, the elementary grating of a zone of interaction is formed in the guide core and/or in the cladding and/or in the substrate.

As we have previously seen, the set of elementary gratings of the various zones of interaction in series, forms a grating. The characteristics of an artificial cladding grating which is to say the characteristics of the zones of interaction of a grating are such that they permit the desired light spectrum to be obtained at the output of the grating.

The component of the invention may comprise several filtering units as previously described, with the zones of interaction of a filtering unit being able to have characteristics that are different from the zones of interaction of another unit.

To create an artificial cladding grating with a spectrum adapted to the desired application, the grating is broken down into elementary gratings, each grating being associated to a zone of interaction. Each zone of interaction of a filtering unit is distinguished from the other zones of interaction of this unit by at least one characteristic selected among the coupling efficiency of the elementary grating corresponding to this zone, the central coupling wave length of this elementary grating and the coupling phase of the elementary grating.

These characteristics may be modified by changing for each elementary zone of interaction at least one structural parameter which must be different from that or those to which it is adjacent.

These parameters may be those of the elementary gratings but also those of the elementary claddings and/or elementary cores. In fact, contrary to the prior art, we can modify the parameters of the cladding and/or of the core thanks to the independence of the core and the cladding.

In this way, the parameters of each zone of interaction can be selected from at least the following:
the length L of the elementary grating,
the period Λ of the elementary grating,
the profile of the elementary grating,
the position of the elementary grating in the zone of interaction,
Δn the amplitude of the effective index modulation induced by the elementary grating,
φ the phase of the elementary grating,
the dimensions of the elementary cladding
the dimensions of the elementary core,
the value of the refractive index of the elementary cladding,
n_{co} the value of the index of the elementary core,
la position of the elementary cladding in the substrate,
la position of the elementary core in the cladding.

In this way, it is possible in each zone of interaction to modify at least one characteristic of the one or more modes spreading in the guide core and/or one or more modes of propagation in the cladding.

In this way, for example at one of the elementary claddings, the larger its dimensions and its index level, the higher the number of cladding modes allowed to spread therefore the greater the number of spectral filtering bands possible. This may be an advantage if seeking multiple filterings or to have more flexibility in the choice of a filtering mode.

If seeking to limit the number de cladding modes that can be coupled, it is of interest on the contrary to reduce the opto-geometrical dimensions of the elementary cladding.

As concerns the elementary core, its dimensions and index level determine the characteristics of the mode, which spreads. Furthermore, the more the index differences between the core, the cladding and the substrate are high, the more there will be potentially a chance of having couplings for low grating periods as shown by the equation (1) (at a wave length of given resonance, the period is inversely related to the index difference between the guided mode of the core and the cladding mode).

By modifying the position of the core, the grating and the cladding, different couplings can be generated. In fact, we can clearly see from the equation (2) that the coupling force depends on the relative position in the plane transversal to the axis of propagation of the profiles of the cladding mode, of the guided mode of the core and the grating.

Some of the zones of interaction parameters may be more difficult to control than others. This is generally the case of the parameters related to the elementary grating. These parameters are in particular:
the amplitudes of the effective index modulation defined in particular by the differences of patterns of the elementary gratings applied to the guide core and/or to the cladding,
the periods of the gratings defined by the pitch values of the patterns and effective indices of the coupling modes concerned.

Also advantageously, we will prefer to create an elementary grating with a pattern whose period and/or amplitude is/are constant and to modify the other parameters.

According to a first embodiment the elementary gratings of a filtering unit have a pattern whose period and/or amplitude is/are constant, where each elementary grating is associated to an elementary cladding, whose section in a plane perpendicular to the direction of propagation of a light wave and/or centring with respect to the elementary core of the corresponding zone of interaction, is different to those of the other elementary claddings of the said unit.

According to a second embodiment, the elementary gratings of a filtering unit have a pattern whose period and/or amplitude are constant, where each elementary grating is associated to an elementary core, whose section in a plane perpendicular to the direction of propagation of a light wave and/or centring with respect to the elementary cladding of the corresponding zone of interaction, is different to those of the other elementary claddings of the said unit.

According to a third embodiment, the elementary gratings of a filtering unit have a pattern whose period and/or amplitude is/are constant, the function defined by these elementary gratings comprising phase changes.

These different variants may of course be combined between one another.

To fabricate these phase offsets, it is possible for example to form an offset of the profile of the grating formed by the set of elementary gratings between each elementary grating and/or elementary cladding.

This offset corresponds to a change in value of the function phase carried out by the elementary grating and not to an interruption of this function.

A light wave introduced in the various zones of interaction of the component of the invention, from the core may therefore be filtered. In fact, one or more guided modes of the light wave introduced into the core are coupled in each zone of interaction p (where p is a whole number between 1 and m and m≧2) by the corresponding elementary grating, to one or more modes of the elementary cladding associated to this zone, for the wave lengths λⱼ defined in the relationship (1). The coupled part of the light wave in the one or more cladding modes may or may not be recovered at the output of the cladding and the non coupled part of the wave continues to be transported by the core to another zone of interaction to an output of the core. The light wave successively filtered by each zone of interaction is finally recovered at the output of the core.

Regardless of the embodiment, the filtering unit of the invention may comprise between two consecutive elementary claddings or between two consecutive groups of elementary claddings, an element for dissipating all or part of the cladding modes. In this way, a dissipating element can be positioned between consecutive claddings or consecutive groups of elementary claddings.

By dissipation of a cladding mode, it is meant that the guided light energy in the cladding mode is lost or dissipated outside of the cladding and the core.

This dissipation of one or more cladding modes permits the interactions between the elementary gratings to be reduced or eliminated simply whereas to avoid these interactions, it is usually necessary to set the parameters of the respective phases of these gratings precisely.

According to a first embodiment, this dissipating element is created by an intermediate cladding positioned between two elementary claddings whose section is smaller at least one of the sections of the two elementary claddings. According to a second embodiment, this dissipating element is created by a reduction in the section between two elementary claddings.

According to another embodiment, this dissipating element is created by a zone of the substrate positioned between two elementary claddings.

The component of the invention may comprise among others a sampling element, connected optically to the cladding of the filtering unit so as to sample part or all of the filtered part of the wave. In this way, the sampling element permits both spectral measurement of the filtered part to be created and to deduce a spectral measurement of the non-filtered part without attenuating the non-filtered signal.

The component of the invention is especially applied to the creation of a gain flattening filter. In this case, the component comprises at least one filtering unit, whose zones of interaction are have their parameters set so that a light wave comprising several spectral bands with different amplitudes, after passing through the said unit, is transformed into a light wave whose spectral bands all have the same amplitude.

The use of such a component is particularly interesting for an optical amplifier, in order to recover at the output of the amplifier a light wave whose spectral bands all have the same amplitude.

The component of the invention is also applied for the creation of a liner filter. In fact, a linear filter is a filtering component whose spectral transfer function is linear with respect to the wavelength. The use of such a component permits for example the frequency of a laser source to be stabilised. In particular, passing a laser signal with a narrow spectral band around a central wave length λ₀ through a filter of the invention provides at the output a signal that is proportional to this wave length: T(λ₀)=aλ₀+β where β is a constant. The slightest spectral offset in one direction or another of the spectrum then results in a drop or an increase of the output signal. It is then possible to create a servo control of this output signal to a command of the laser that acts on the spectral position of the emission and thus stabilise the source. The stabilisation of the laser source thus only requires a filter and a photo-detector, a spectrum analyser is no longer required.

According to one preferred mode, the elementary claddings and/or the guide core and/or the elementary gratings may be created by all types of technique permitting the refractive index of the substrate to be modified. We can mention in particular the ion exchange, the ionic implantation and/or the radiation techniques for example by laser exposure or laser photo inscription even by depositing layers.

The ion exchange technology in glass is of particular interest but other substrates than glass may of course be used such as for example crystalline substrates of the KTP or LiNbO₃, or even the LiTaO₃ types.

More generally, the gratings may be created by any techniques permitting the effective index of the substrate to be changed. In addition to the techniques previously mentioned, we can add in particular the techniques for creating gratings by etching of the substrate. This etching may be carried out above the cladding or in the portion of cladding of the zones of interaction and/or in the core portion of the zones of interaction.

The grating pattern of the grating may be obtained either by laser sweeping in the case of radiation, or by a mask. The latter may be the mask, which permits the core, and/or the cladding to be obtained or a specific mask for creating the grating.

The invention also relates to a method for fabricating an integrated optics component as previously defined, the cladding, the guide core and the grating of each filtering unit being created respectively by a modification of the refractive index of the substrate so that at least in the part of each elementary cladding next to the core and at least in each zone of interaction, the refractive index of the elementary cladding is different from the refractive index of the substrate and lower than the refractive index of the elementary core and so that each elementary zone of interaction has at least one structural parameter different from that or those to which it is adjacent.

According to one preferred embodiment, the method of the invention comprises the following steps:
a) introduction of a first ionic species in the substrate to permit the optical cladding to be obtained after step c),
b) introduction of a second ionic species in the substrate to permit the guide core to be obtained after step c),
c) burying of the ions introduced in steps a) and b) to obtain the cladding and the guide core,
d) creation of the grating.

The order of the steps may of course be inverted.

The first and/or the second ionic species is/are introduced advantageously by an ionic exchange, or by ionic implantation.

The first and second ionic species may be the same or different.

The introduction of the first ionic species and/or the second ionic species may be made with the application of an electrical field.

In the case of an ionic exchange, the substrate must contain ionic species capable of being exchanged.

According to one preferred embodiment, the substrate is made of glass and contains Na⁺ ions introduced beforehand, the first and second ionic species are Ag⁺ and/or K⁺ ions.

According to a first embodiment, step a) comprises the creation of a first mask comprising a pattern capable of creating the cladding, the first ionic species being introduced through this first mask and step b) comprises the elimination of the first mask and the creation of a second mask comprising a pattern capable of creating the core, the second ionic species being introduced through this second mask.

According to a second embodiment, the step a) comprises the creation of a mask comprising a pattern capable of creating the cladding and the core, the introduction of the first and the second ionic species of steps a) and b) being carried out through this mask.

The masks used in the invention are for example made of aluminium, chrome, alumina or dielectric material.

According to a first embodiment of step c), the first ionic species is buried at least partially prior to step b) and the second ionic species is buried at least partially after step b).

According to a second embodiment of step c), the first ionic species and the second ionic species are buried simultaneously after step b).

According to a third embodiment of step c), the burying comprises the depositing of at least one layer of refractive material, whose index is advantageously lower than that of the cladding, on the surface of the substrate.

This mode may of course be combined with the two previous modes.

Advantageously, at least part of the burying is carried out with the application of an electrical field.

Generally prior to burying with an electrical field and/or the depositing of a layer, the process of the invention may comprise among others burying by re-diffusion in an ionic bath.

This step of re-diffusion may be carried out partially prior to step b) to re-diffuse the ions of the first ionic species and partially after step b) to re-diffuse the ions of the first and second ionic species. This re-diffusion step may also be carried out completely after step b) to re-diffuse the ions of the first and second ionic species.

By way of example, this re-diffusion is obtained by plunging the substrate in a bath containing the same ionic species as that previously contained in the substrate.

Step d) for creating the grating may be applied independently of steps a) and b) or created simultaneously during step a) and/or de step b) by using for example the same masks.

Other characteristics and advantages of the invention will become clearer from the following description, in reference to the figures of the appended drawings. This description is given by way of illustration and is not restrictive.

### BRIEF DESCRIPTION OF THE FIGURES

FIG. 1 already described, shows diagrammatically the trace of an index modulation Δn, obtained for elementary gratings R1 to R4,

FIG. 2 already described shows diagrammatically in cross section, an example of an optical fibre filter, comprising 3 elementary gratings,

FIGS. 3a and 3b respectively show the distribution of the light energy of a light wave for three central wave lengths λ₁, λ₂, λ₃, at the input and output of a component such as that of FIG. 2,

FIG. 4 shows diagrammatically in cross section, a first embodiment of a component of the invention,

FIGS. 5a and 5b respectively show the evolution curves of the coupling wave length λ and the coupling coefficient K of a zone of interaction according to the decentration δx between the core and the cladding for different sizes L₁, L₂ and L₃ of cladding and FIG. 5c shows the transfer functions of the various zones of interaction according to the wave length,

FIG. 6 shows diagrammatically in cross section a second embodiment of the component of the invention,

FIG. 7 shows diagrammatically in cross section a third embodiment of the component of the invention,

FIGS. 8a and 8b show diagrammatically in cross section a fourth embodiment of the component of the invention,

FIGS. 9a to 9d show diagrammatically in cross section a partial filtering unit comprising a dissipating element,

FIG. 10 shows a component of the invention with several filtering units,

FIG. 11 shows diagrammatically in cross section an example of an application of the component of the invention for an optical amplifier,

FIGS. 12a to 12d show diagrammatically in cross section an example the creation process for a component of the invention,

FIGS. 13a to 13d show diagrammatically variants of creation for mask patterns permitting a grating in the core to be created, and

FIG. 14 shows in cross section a variant of creation for a component of the invention with a grating in the cladding.

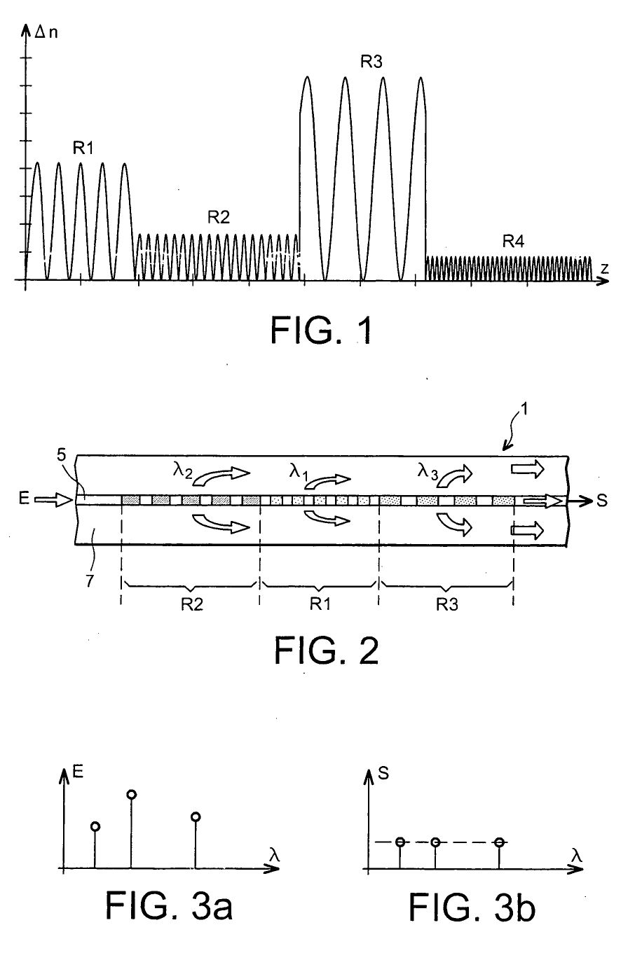

### DETAILED DESCRIPTION OF EMBODIMENTS OF THE INVENTION

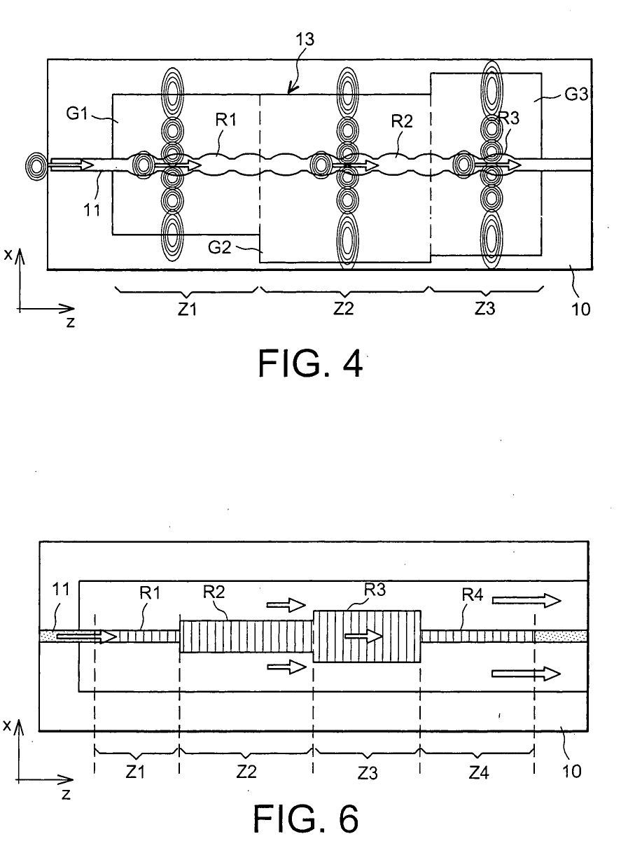

FIG. 4 shows diagrammatically in cross section one embodiment of an evolved filtering component of the invention. This cross section contains the direction z of propagation of the light wave in the core. This cross section is in a plane parallel to the surface of the substrate, given that in a plane perpendicular to the surface of the substrate, it would be possible to have the same set up.

The component shown in this figure, comprises in one substrate 10, a single filtering unit composed of an optical guide core 11, an optical cladding 13, independent of the core and de three zones of interaction in series Z1, Z2, Z3. Each zone of interaction Zp (where p ranges from 1 to 3) is defined by a portion of the cladding 13 called the elementary cladding Gp surrounding a portion of the core, in one zone of the substrate comprising an elementary grating Rp. The refractive index of each elementary cladding is different from the refractive index of the substrate and lower than the refractive index of the core at least in the part of the elementary cladding next to the core.

The different elementary gratings R1, R2, R3 of the filtering unit form a grating created in this example in the core 11, by a variation of the section of the core. In this figure the period of the grating is constant as well as the variations of the section of the core. The grating could also have been created in the cladding or in the cladding and the core or even in the substrate next to the cladding.

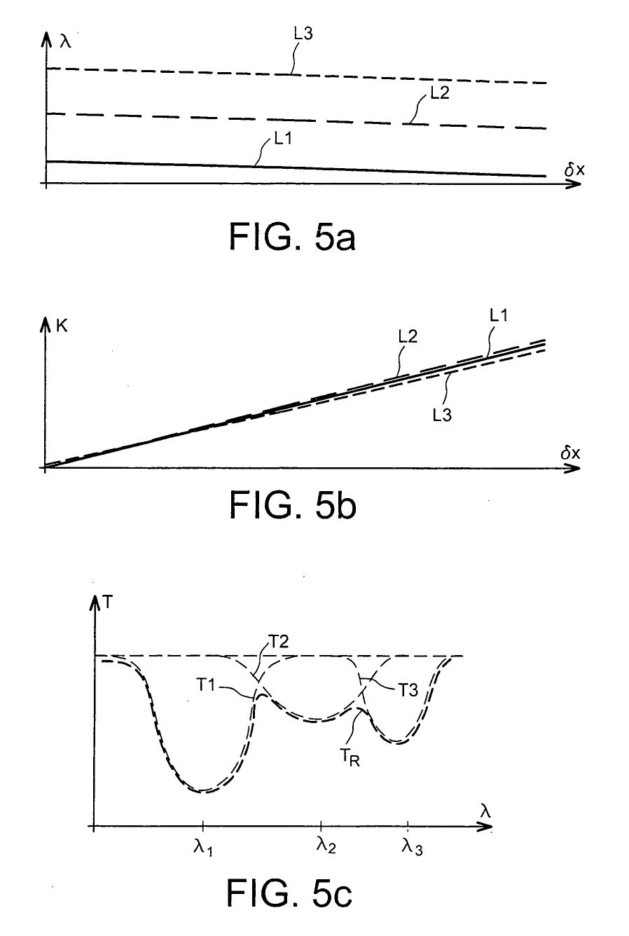

The characteristics of each of the zones of interaction Z1, Z2, Z3 are adapted (see FIG. 5c) in order to obtain the desired spectrum taking into account the input light wave.

To do so, in this embodiment, due to the independence of the core and the cladding, the desired characteristics are obtained for the zones of interaction, by modifying the sections of the elementary claddings G1, G2, G3 and/or their decentration with respect to the core guide.

The series of concentric circles shown in this figure diagrammatically shows the guide and cladding modes concerned by the coupling.

In fact, the effective index distribution of the cladding modes and the guided mode in the core depends on the size of the cladding.

Furthermore, as the coupling force is defined by the recovery integral of the modes, a decentration of the cladding with respect to the core permits the coupling coefficient of a mode to be varied without causing major disruption to the effective indices. This is particularly true for a coupling between the fundamental mode of uneven function and non-symmetrical even modes. When the core, the cladding and the grating are centred, the recovery integral of the uneven fundamental mode for a cladding mode pair is nil. In a cladding-core decentration, this integral becomes an increasing function of the offset δx between the core and the centre of the cladding whereas the coupling wavelength remains identical.

If the section, for example the width L of the cladding is modified, the recovery integral of the modes is only slightly modified, however the coupling wavelength changes.

In the example of FIG. 4, the elementary claddings and the elementary gratings are positioned end to end but it would also have been possible to create these claddings and these gratings in non connected zones of the substrate, thus creating non connected zones of interactions connected by the guide core.

FIGS. 5a and 5b resume this principle simply.

FIG. 5a shows the evolution of the resonance wave length λ according to the offset δx between the core and the cladding respectively for three values of cladding width L1, L2, L3. It can be remarked that there is a slight decrease according to δx and a major difference according to L.

FIG. 5b shows the evolution of the coupling coefficient deduced from the recovery integral defined by the equation (2). The three widths of cladding provide more or less equivalent coupling values. A high variation of the coupling coefficient K can be observed depending on the offset δx.

FIG. 5c shows an example of a transfer function T for different zones of interaction according to the wave length λ as well as the resulting transfer function, this function permitting, from an input signal E with different amplitudes according to the central wave lengths, in this example, an output signal S to be obtained that has more or less the same amplitudes for these central wave lengths. In this figure, the curves T1, T2, T3 show the transfer functions for each of the zones of interaction whereas the curve TR provides the resulting transfer function of the grating for this filtering unit.

We can clearly see from these curves, an example of an evolved spectrum of a filtering component of the invention.

FIG. 6 shows diagrammatically in cross section another embodiment of an evolved filtering component of the invention comprising a filtering unit.

As previously seen, this cross section contains the direction z of propagation of the light wave in the core and it is in a plane parallel to the surface of the substrate, given that in one plane perpendicular to the surface of the substrate, it would also be possible to have the same set up.

In this example, the filtering unit shown comprises 4 zones of interaction Z1, Z2, Z3, Z4; each zone of interaction Zp (where p is a whole number between 1 and 4) is respectively formed by an elementary cladding, a portion of the core 11 and an elementary grating Rp.

In this example, the gratings Rp are formed by a variation of the refractive index of the core.

These gratings have a uniform pattern and a constant period.

To obtain an evolved spectrum, in this example a core of variable section was created, the gratings formed in the core have therefore also a variable section. In this way, in this figure, the gratings R1 and R4 are at least narrower (in the direction x) than the gratings R2 and R3, among others the width of the grating R2 is at least narrower than that of the grating R3.

It would also have been possible to modify the section of the cladding and the core or simply the cladding, depending on if the grating is part of the cladding and the core or simply the cladding.

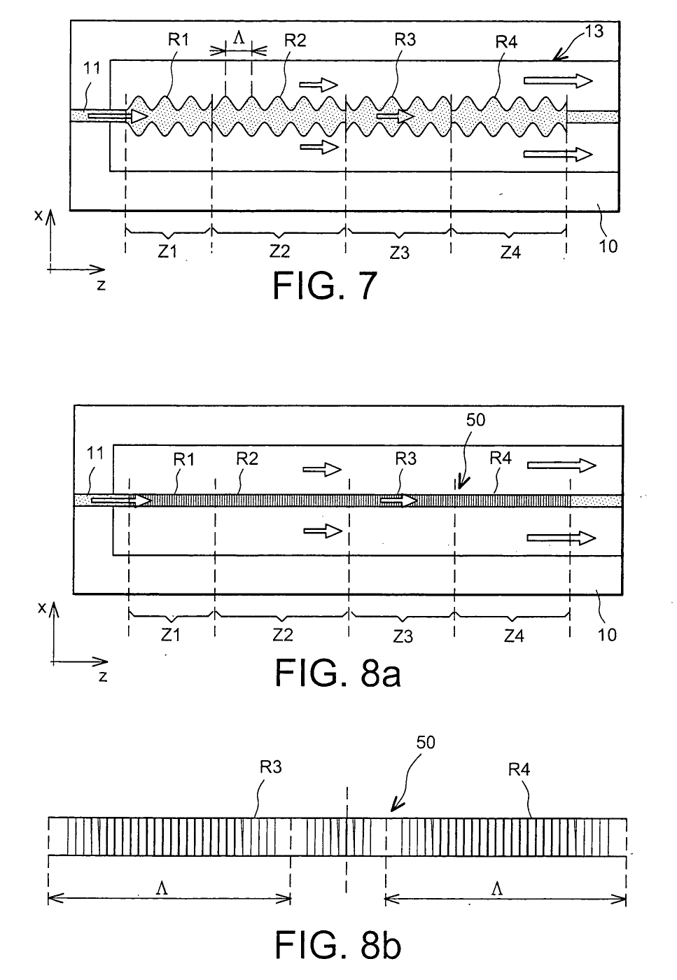

FIG. 7 shows diagrammatically in cross section another embodiment of an evolved filtering component of the invention comprising a filtering unit with four zones of interaction.

This cross section also contains the direction z of propagation of the light wave in the core and it is in a plane parallel to the surface of the substrate.

In this figure, as in FIG. 6, the elementary claddings all have the same section and are all centred with respect to the core 11. Also, to obtain at the output of the zones of interaction, a spectrum adapted to the application in question, elementary gratings with patterns, whose period and amplitude are constant but offset with respect to one another, are created.

In this example, the phase jumps are formed by a modification of the phase of the grating profile between two elementary gratings.

In the case of a grating formed by a variation of the section of the core, a width function l(z) is defined that depends on a longitudinal co-ordinate z to the axis of propagation of the modes:

$$1 ( z ) = {1}_{core} + \frac{Δ 1}{2} \times [ a + cos ( \frac{2 π}{Λ} z + φ ( z ) ) ] \qquad ( 3 )$$

where:
   lcore is the width of the core outside of the grating,
   Δl is the amplitude of variation of the width of the core,
   a is the offset term, (a=1 in FIG. 7),
   Λ is the period of the grating,
   φ is the phase of the grating.

The phase jumps are introduced by defining a function φ(z) by steps on the different lengths of the elementary gratings. As we can see, the grating pattern has a constant period and amplitude, but we can remark the offsets due to the changes in phase values φp on the different lengths.

This solution is therefore particularly interesting. First of all, the pattern is uniform apart from the phase offsets which simplifies its design. Furthermore, as this pattern can also be created directly in two dimensions from for example the mask used to introduce the ions, the creation mode is simplified in comparison to the fibre solutions for which a mask with single dimensional variation of amplitude is used. In fact, in the fibre solutions, the phase offset cannot be controlled in general by the distributed form of the pattern but by the insertion of an offsetting segment. The phase offset created by this segment is physically defined by the phase offset induced between the guide and cladding modes, which spread there. A phase offset of π is in this way obtained by the insertion of a segment of length Λ/2 modulo Λ.

In our case, the phase offset is simply defined by the succession of φp values given to the function l(z) of the equation (3).

Phase jumps in a grating formed by segmentation of the core and/or the cladding may also be obtained by variation of this segmentation. By way of example, the FIG. 8a shows a grating formed by segmentation of the core and comprising phase jumps. This cross section also contains the direction z of propagation of the light wave in the core and it is in a plane parallel to the surface of the substrate, given that in a plane perpendicular to the surface of the substrate, it is also possible to have the same set up.

These phase jumps are created by modification of the segmentation of the core at the output of each zone of interaction, as can be seen in FIG. 8b which is an enlarged view of the output of the zone Z3 with the reference 50 (we can observe in this view the succession of the core zones with a different refractive index), the dotted line identifies the position of the phase change.

This segmentation corresponds to a modification of the refractive index of the core in the direction of the axis z, each segment corresponding to a section of the core in a plane perpendicular or not to the axis z.

Once again, the pattern is defined in two dimensions by a mask for example based on a sinusoidal type mathematical function.

Regardless of the previously described embodiment, in practice, the elementary gratings can interfere with one another and the spectral transmission curve resulting from placing the gratings in series is thus not just the result of the multiplication of the elementary transmissions (see FIG. 5c). Also, to avoid the appearance of interference noise, the parameters of the zones of interaction must be defined precisely.

Thus in one particularly advantageous embodiment of the invention, which may be combined with the embodiments previously described and which is possible thanks to the independence of the cladding and the guide core, we can simplify the adjustment of the parameters of the zones of interaction by totally or partially isolating the said zones which permits the interference problems to be limited or avoided. The global response of all of the zones of interaction thus has little or no interference noise.

This isolation is obtained by a dissipating element which permits all or part of the coupled cladding modes in each zone of interaction to be dissipated, so that they cannot be recoupled later by an elementary grating in another zone of interaction and in this way interfere with the fundamental guided mode in the guide core.

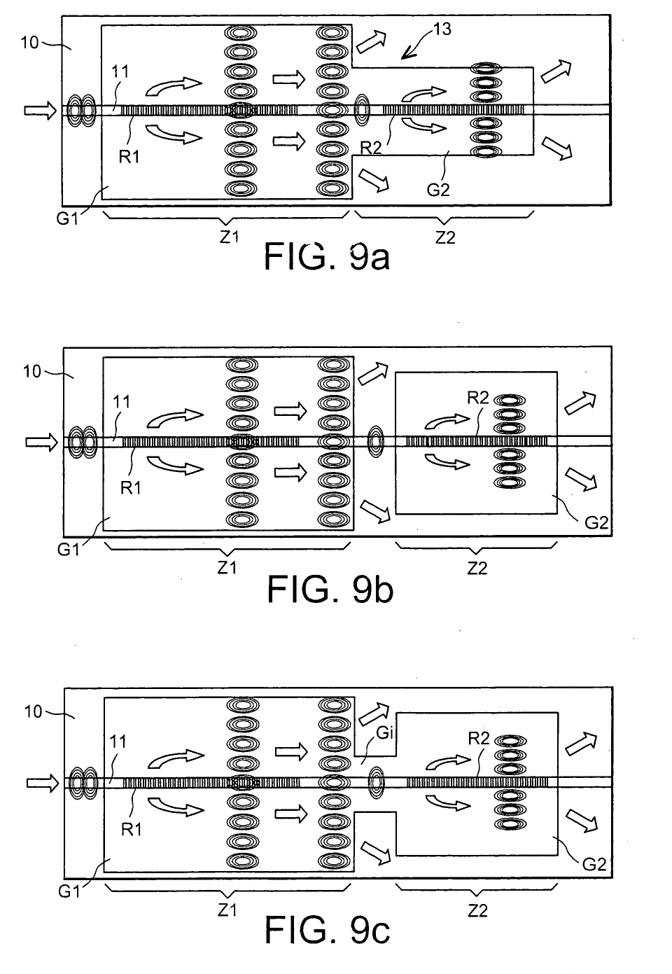

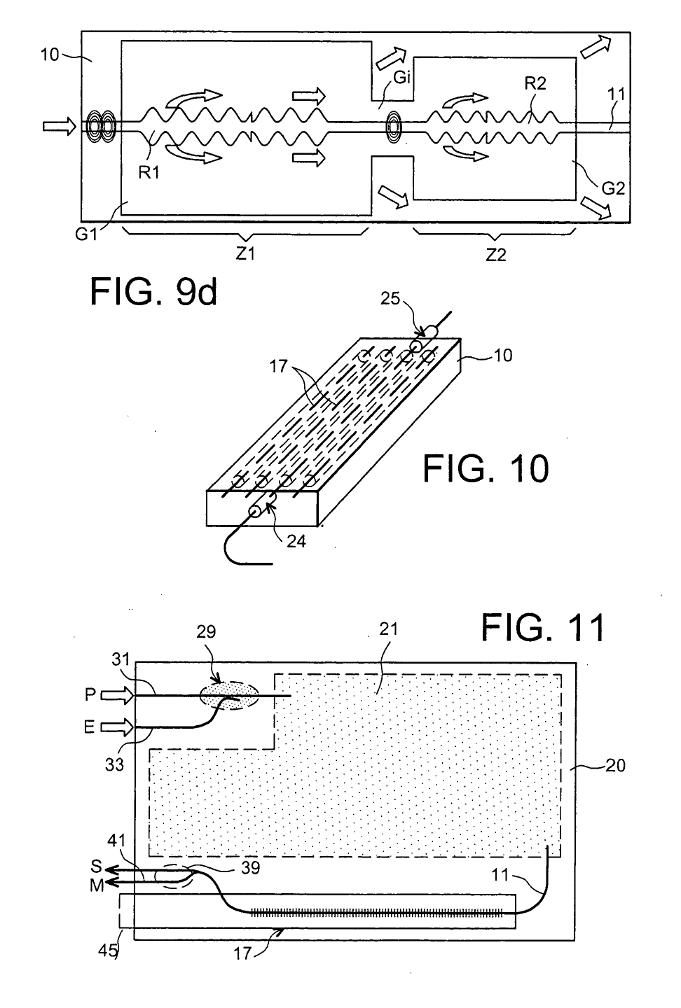

A first embodiment of this isolation is shown diagrammatically in cross section in FIG. 9a. This cross section contains the direction z of propagation of the light wave in the core.

This figure shows two zones of interaction Z1 and Z2 made from the substrate 10, of two elementary claddings G1 and G2, gratings R1 and R2 and the core 11. In this example, the dissipating element by changes of sections between the different elementary claddings. The cladding G2 has a section smaller than that of the cladding G1 so that the one or more guided modes in the cladding G1 cannot spread in the following cladding G2 and be lost in the substrate 10; only the guided mode in the core 11 penetrates the second elementary cladding G2. No interference is therefore possible.

A second embodiment of a dissipating element is shown diagrammatically in cross section in FIG. 9b. This cross section contains as previously the direction z of propagation of the light wave in the core.

This example is particularly advantageous when the sizes of the claddings are similar. To this end, the cladding is interrupted between each zone of elementary interaction. In this way, the elementary claddings are distant from one another and the dissipating elements are formed by the zones of the substrate situated between two elementary claddings. This is made possible thanks to the independence of the core and the cladding which permits the continuity of the core between the different elementary claddings. The fundamental guided mode in the core is not disrupted in this way and the cladding modes are on the other hand dissipated in the substrate at the end of each of the elementary claddings.

A third embodiment of a dissipating element is shown diagrammatically in cross section in FIG. 9c (this cross section contains as previously seen the direction z of propagation of the light wave in the core).

This example is a combination of the two previous ones. In this example, the elementary claddings are only partially interrupted so as to ensure the continuity with an intermediate cladding G1, positioned between two elementary claddings. The core 11 traverses this intermediate cladding G1 but it is not associated to a grating, which means that the core and the intermediate cladding are not coupled. The intermediate cladding has a smaller section than those of the elementary claddings and forms the dissipating element.

This last solution offers the advantage of limiting the number of transitions between the elementary claddings and the substrate for the guide core (as in the first example) whilst permitting successions of elementary claddings of similar sizes.

By way of example, the elementary claddings may have a width (considered in a direction perpendicular to the axis z and perpendicular to the surface of the substrate) close to 80 μm whereas the intermediate or transition cladding has a width close to 15 μm and a length of around one millimetre.

In this way, the use of isolation between the elementary claddings permits easier application of the filtering unit of the invention, as it does not require complete control of the spectral response of a succession of elementary gratings. On the contrary, the gain in simplicity is lost in efficiency. Furthermore, as it is no longer possible to adjust the resonances between the gratings and the appearance of asymmetry, the accumulated length (considered in the direction z of propagation) of the gratings is longer.

Depending on the applications, filtering elements are used with or without isolation between elementary claddings.

A last embodiment of this isolation is shown diagrammatically in cross section in FIG. 9d (this cross section contains as previously seen the direction z of propagation of the light wave in the core).

This example is an intermediate solution that uses both an independent succession of gratings with phase jumps and a dissipating element. This solution is particularly advantageous as the response of a phase jump grating and its practical creation are straightforward and the insertion of phase jumps in a grating furthermore permits the creation of disymmetries and counter resonances which can permit a major reduction of the accumulated length of the grating.

In this way, FIG. 9d shows an identical solution to that of FIG. 9c but the two elementary gratings R1 and R2 which were placed in series have phase jumps.

In all of the examples previously provided, the pattern of the grating is advantageously created in the substrate in two dimensions, which permits, apart from the previously described advantages, to create several filtering units on a same substrate.

This advantage permits in particular to increase the creation profitability of the component by creating several filtering units on a same substrate that can be created simultaneously and placed in parallel within a same substrate.

An embodiment of a filtering component comprising several filtering units 17 in a same substrate 10 is shown diagrammatically in perspective in FIG. 10. Each de these units 17 has parameters that are different from its neighbours so as to cover all of the variations of characteristics of the filters within the limits of reproducibility of the creation mode in question.

In some applications, after the creation of these units, each component is tested in order to select the filtering unit which is the closest to the desired filter. At least, this unit is connectorised and the component is prepared for the application in question.

This connectorisation may be carried out as shown in FIG. 10 by two fibre hoops added to the sidewalls of the substrate.

It should be highlighted that this mode of creation does not require very much bigger substrate sizes than for those of a component with a single filtering unit. In fact, the artificial cladding gratings are generally quite narrow (for example, around a hundred micrometers) whereas the substrates have a minimum width of several mm to ensure adequate mechanical resistance.

The filtering component of the invention may be associated to numerous optical elements which may or may not be integrated onto the same substrate as the filtering component.

In particular, a sampling and/or measurement device may be associated to the input and/or to the output of the component. This device may be positioned at the output of the cladding to recover all or part of the light wave extracted from the core by the different elementary gratings or at the output of the core (as shown FIG. 11).

FIG. 11 shows by way of example in cross section in a plane parallel to the surface of the substrate several optical elements associated to the component of the invention to create an integrated optics amplifier.

This figure shows a substrate 20, in which is formed a filtering unit 17 in compliance with the invention capable of creating for example a gain flattening filter, this unit comprising a guide core 11, a guide core 41, an output 39 obtained by bringing the cores 11 and 41 together, an amplification element 21 shown diagrammatically by a zone in dotted lines, two guide cores 31 and 33 and an input coupler 29 obtained by bringing the two cores 31 and 33 together. The core 41 and the coupler 39 form a sampling element of one part of the wave transported by the core 11.

A pump signal P is introduced in the core 33 whilst the light wave E to be amplified is injected into the core 31. In the coupler 29, the pump signal is superposed onto the light wave E in the core 31 that is connected to the amplification element. The light wave E is then amplified in the element 21. With the output of the amplification element connected to the filtering unit 17 by the guide core 11, the amplified wave is filtered by the unit 17 so that the wave S recovered at the output of the core 11 has a uniform gain for all its spectral bands.

To control the amplification, the coupler 39 samples part of the wave transported by the core 11. This sampled part M is then transported by the core 41 to be measured for example by a measuring element not shown, such as a photodetector connected to the end of the core 41.

According to one advantageous embodiment, the sampling element shown in dotted lines with the reference 45 (for example a photo-detector) is situated directly at the output of the cladding of the unit 17 in order to sample part of the wave filtered by the unit 17, which permits both to carry out a spectral measurement of the filtered part and to deduce a spectral measurement of the non-filtered part without attenuating the non-filtered signal.

Of course, the filtering component of the invention may be associated to many other optical elements, such as for example a multiplexer/demultiplexer, a wide band laser source with spontaneous emission, etc.

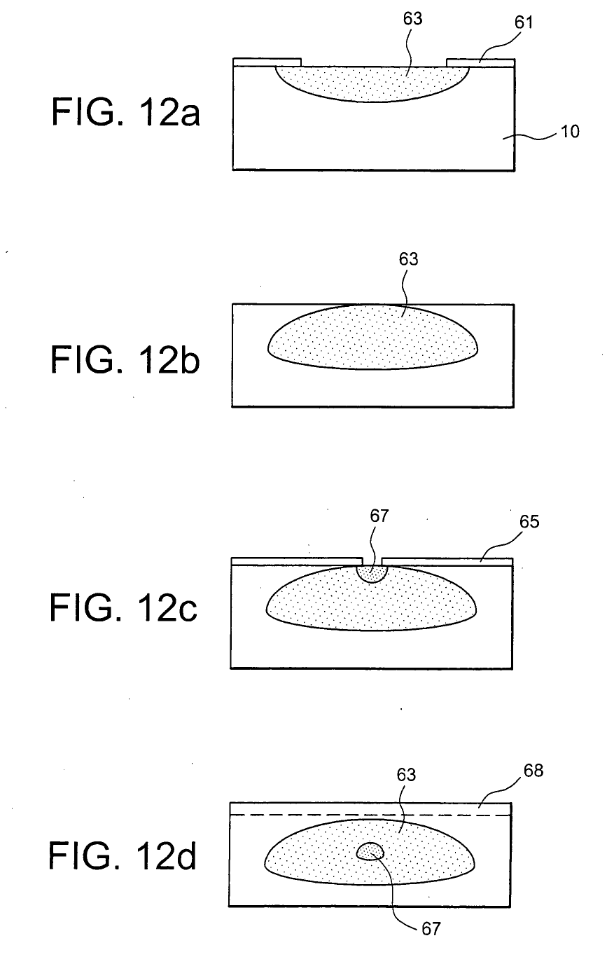

FIGS. 12a to 12d illustrate an example of a fabrication method of a component of the invention, from the ion exchange technology.

These figures are cross sections in a plane perpendicular to the surface of the substrate and perpendicular to the direction z of propagation and containing a zone of interaction.

In this way, FIG. 12a shows a substrate 10 containing ions B.

A first mask 61 is created for example by photolithography on one of the faces of the substrate; this mask comprises an opening determined according to the dimensions (width, length) of the cladding that we wish to obtained.

A first ionic exchange is then carried out between the A ions and B ions contained in the substrate, in a zone of the substrate situated next to the opening of the mask 61. This exchange is obtained for example by soaking the substrate equipped with the mask in a bath containing A ions and by possibly applying an electrical field between the face of the substrate on which the mask is placed and the opposite face. The zone of the substrate in which this ionic exchange is carried out forms the cladding 63, which as we have previously seen may be non-uniform in dimensions and have variable centring.

To bury this cladding, a step for re-diffusing the A ions is carried out with or without the assistance of an electrical field applied as we have previously seen. FIG. 12b, shows the cladding after a step where it is partially buried. The mask 61 is generally removed prior to this step.

The creation of the cladding of the invention is therefore similar to the creation of a guide core but with different dimensions.

The following step shown in FIG. 12c consists of forming a new mask 65 on the substrate, for example by photolithography possibly after cleaning of the face of the substrate on which it is created. This mask comprises patterns capable of allowing the creation of a guide core 67 and in particular when the core comprises a grating, the mask patterns 65 can be adapted to the patterns of the grating to be formed.

A second ionic exchange is then carried out between the B ions of the substrate and the C ions that may or may not be the same as the A ions. This ionic exchange may be carried out as seen previously by soaking the substrate in a bath containing C ions and by possibly applying an electrical field.

Finally, FIG. 12d shows the component obtained after the core 67 has been buried obtained by re-diffusion of the C ions and final burying of the cladding, with or without the use of an electrical field. The mask 65 is generally removed prior to this burying step.

The conditions of the first and second ionic exchanges are defined in order to obtain the differences of refractive indices desired between the substrate, the cladding and the core. The adjustment parameters of these differences are in particular the exchange time, the temperature of the bath, the concentration in ions of the bath and the presence or absence of an electrical field.

As an example of an embodiment, the substrate 10 is made of glass containing Na⁺ ions, the mask 61 is made of aluminium and has, if the cladding is uniform, an opening of around 30 μm wide (the length of the opening depends on the desired length of the cladding for the application in question).

The first ionic exchange is carried out with a bath comprising Ag⁺ ions at around 20% concentration, at a temperature of around 330° C. and for an exchange time of around 5 min. Re-diffusion of the ions first takes place in open air at a temperature of around 330° C. and for 30 s, then the cladding thus formed is partially buried in the glass. This burying is carried out by re-diffusion in sodium bath at a temperature of around 260° C. The length of this step depends on the depth of burying desired for the final component. In this way, for a surface component a duration of around 3 minutes is sufficient whereas for a buried component a duration of around 20 minutes will be selected. In this second case, it is also necessary to carry out the burying of the cladding under an electrical field before the second exchange. In this way, a current of 20 mA is applied between two sodium baths on either side of the plate at a temperature of 260° C. for 10 minutes.

The mask 65 is also made of aluminium and has an pattern opening of around 3 μm wide (the length of the pattern depends on the desired length of the core for the application in question).

The second ionic exchange is carried out with a bath also comprising Ag+ ions at around 20% concentration, at a temperature of around 330° C. and for an exchange time of around 5 min, with a re-diffusion of the ions first taking place in open air at a temperature of around 330° C. and for 30 s. Then the core thus formed is partially buried in the glass by re-diffusion in a sodium bath at a temperature of around 260° C. for 3 min. For a buried component, this step is not necessary.

The final burying of the cladding and the core takes place under an electrical field, with the two opposite faces of the substrate in contact with two baths (in this example sodium) capable of permitting a difference in potential to be applied between these two baths. For a surface component, a duration of less than one minute is sufficient, in the case of a buried component a duration of around 30 minutes is used, with the burying being carried out with a current of 20 mA at 240° C.

Many variants of the previously described process may be created. In particular, the burying steps of the cladding and the core may be carried out as previously described during 2 successive steps but they may also be carried out simultaneously in certain cases, with the core having an ionic concentration higher than that of the cladding, it is buried quicker than the cladding, which permits among others to centre the core in the cladding.

The difference in concentration between the core and the cladding is generally obtained either by re-diffusion in a bath of ions forming the cladding or by a difference in concentration of the ions introduced in steps a) and b).

As we have already seen, to bury the cladding and the core, a variant of the process consists of depositing on the substrate 10, a layer of material 68, shown in dotted lines in FIG. 12d. In order to make optical guiding possible, this material must advantageously have a refractive index lower than that of the cladding.

The fabrication of the component of the invention is not restricted to the technique of ion exchange. The component of the invention may also be created by any techniques which permit the refractive index of the substrate to be modified.

Furthermore, as we have already seen, the period, size and position of the grating created, with respect to the core and the cladding, are parameters which can be adapted to suit the applications.

The grating pattern may be defined on the mask permitting the cladding to be created and/or on the mask permitting the core to be created or on the unique mask permitting both the cladding and the core to be created or even on a specific mask solely for the creation of the grating.

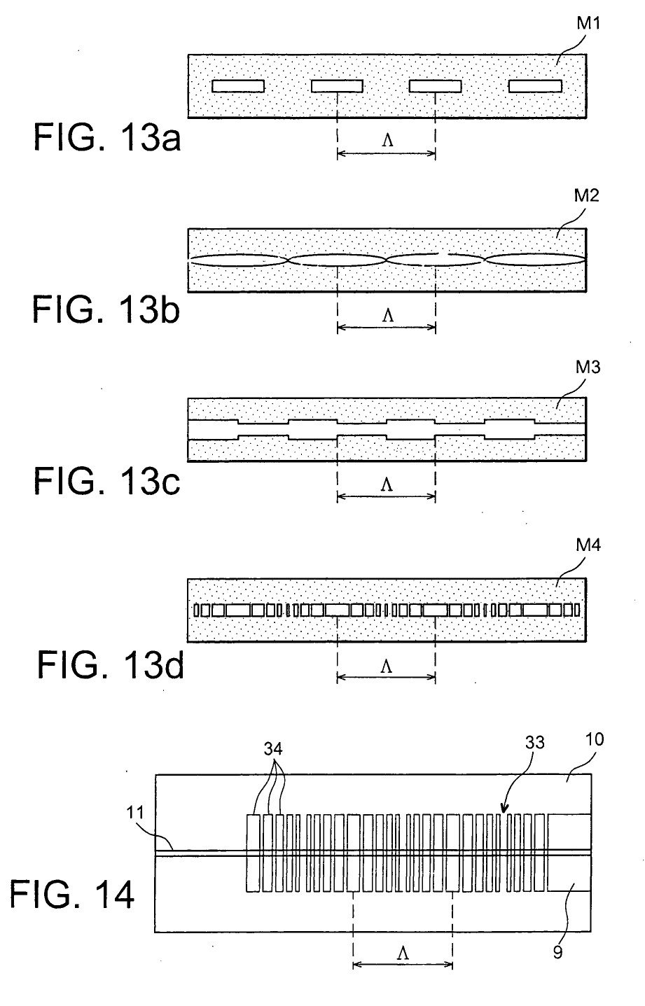

FIGS. 13a to 13d illustrate by way of example some examples for creating masks M1, M2, M3, and M4 permitting an elementary grating to be obtained. These figures are elevation views of the masks and only show the part of the masks permitting the grating to be obtained. The white zones of the mask pattern correspond to the openings of the mask.

These masks permit a periodic grating of period A to be obtained. The masks M1 and M4 permit a grating to be obtained by segmentation whilst the masks M2 and M3 permit a grating to be obtained by variation of the width of the patterns.

These masks may be for example specific masks for the creation of the grating in the core and/or in the cladding or a part of the masks permitting the core and/or the cladding to be obtained, the grating being then created at the same time as the core and/or the cladding.

FIGS. 4, 6, 7, 8 and 9 previously described illustrate examples of gratings formed in the guide core.

FIG. 14 shows an embodiment of an elementary grating 33 created by segmentation in an elementary zone of interaction both in the core 11 and in the cladding 9.

In this way, in FIG. 13, the grating 33 is formed in the cladding 9 by alternation of the period Λ, with zones 34 of variable lengths considered in the direction z of propagation of a light wave. As the core is furthermore included in the cladding at least in the zone of interaction, the grating is also part of the core, in other words the core also comprises zones with refractive indices that are different from that of the rest of the core.

The gratings may be formed by any traditional techniques which permit the effective index of the substrate in the core and/or in the cladding to be modified locally.

They may therefore be created during ionic exchanges permitting the core and/or the cladding to be created or during a specific ionic exchange. They may also be obtained by etching of the substrate at the o zone of interaction or by radiation. In particular, the gratings may be obtained by exposure of the core and/or the cladding to a CO₂ type laser. The laser produces localised heating which permit the ions to be re-diffused locally and consequently include the pattern of the gratings.

By way of example, the substrate may be swept with a laser beam for example modulated in amplitude so as to introduce a modulation of the grating to the desired pitch.

### REFERENCES

[1]: U.S. Pat. No. 5,430,817 by A. M. Vengsarkar,
[2]: A. M. Vengsarkar, J. R. Pedrazzani, J. B. Judkins and P. J. Lemaire, “Long-Period fiber-grating-based gain equalizers”, Opt. Lett. (1996) vol 21 no 5 pp 336-
[3]: EP 0 897 124 de G. Xijia,

1. An integrated optics filtering component comprising:
a substrate; and
a filtering unit arranged in said substrate, said filtering unit comprising:
an optical guide core,
an optical cladding independent of the core, and
at least two elementary zones of interaction arranged in series, each of said at least two elementary zones of interaction including a structural parameter that is different from a structural parameter of an adjacent elementary zone of interaction, each of said at least two elementary zones of interaction including an elementary grating configured to couple modes between the guide core and the optical cladding,
wherein at least one portion of the optical cladding surrounds a corresponding at least one portion of the optical guide core, and
wherein a refractive index of each of said at least one portion of the optical cladding is different from a refractive index of the substrate and lower than a refractive index of the corresponding at least one portion of the optical guide core at least in a part of the optical cladding that surrounds the optical guide core.

2. The component of claim 1, wherein each of said at least one portion of the optical cladding has a refractive index higher than that of the substrate.

3. The component of claim 1, wherein the elementary grating of one said at least two elementary zones of interaction is formed in the guide core and/or in the cladding and/or in the substrate.

4. The component of claim 1, wherein each elementary zone of interaction is differentiated from another zone of interaction by at least one characteristic selected from a group consisting of a coupling efficiency of the elementary grating corresponding to this zone, a central coupling wavelength of the elementary grating and/or a coupling phase of the elementary grating.

5. The component of claim 1, wherein in each zone of interaction, the structural parameter is selected from a group consisting of at least:
a length L of the elementary grating,
a period Λ of the elementary grating,
a profile of the elementary grating,
a position of the elementary grating in the zone of interaction,
an amplitude Δn of an effective index modulation induced by the elementary grating,
a phase φ of the elementary grating,
dimensions of the at least one portion of the optical cladding,
dimensions of the at least one portion of the optical guide core,
a value of the refractive index of the at least one portion of the optical cladding,
a value of the index of the at least one portion of the optical guide core,
a position of the at least one portion of the optical cladding in the substrate, and
a position of the at least one portion of the optical guide core in the cladding.

6. The component of claim 1, wherein a grating including the elementary grating of each zone of interaction has a profile that is constant in period and/or amplitude.

7. The component of claim 6, wherein each of said at least one portion of the optical cladding of a filtering unit has a section in a plane perpendicular to the direction of propagation of a light wave and/or a centering with respect to the corresponding at least one portion of the optical guide core of the zone of interaction different from those of a remaining of said at least one portion claddings of said filtering unit.

8. The component of claim 6, wherein each corresponding at least one portion of the optical guide core of a filtering unit has a section in a plane that is perpendicular to a direction of propagation of a light wave and/or a centering with respect to the at least one portion of the optical cladding of a corresponding zone of interaction different to those of the other elementary cores of the said unit.

9. The component of claim 6, wherein a function defined by elementary gratings of said at least two elementary zones of the filtering unit comprises phase changes.

10. The component of claim 9, wherein the phase changes are produced between each elementary grating by an offset corresponding to a change in value of a function phase created by the profile of the elementary grating.

11. The component of claim 1, wherein the filtering unit comprises a dissipating element configured to dissipate all or part of the cladding modes and arranged between two consecutive elementary claddings or between two consecutive groups of elementary claddings.

12. The component of claim 11, the dissipating element is created by a reduction in section between two elementary claddings.

13. The component of claim 11, wherein the dissipating element is created by includes an intermediate cladding, positioned between two elementary claddings, a section of the intermediate cladding being smaller than at least one of the sections of the two elementary claddings.

14. The component of claim 11, wherein the dissipating element is created in a zone of the substrate positioned between two elementary claddings.

15. The component of claim 1, wherein a sampling element is optically connected to the cladding of the filtering unit.

16. The component of claim 1, comprising at least two filtering units.

17. The component of claim 1, wherein the filtering unit is a gain flattening filter.

18. A method of manufacturing an integrated optics component comprising:
providing a substrate; and
modifying a refractive index of said substrate to create a filtering unit that comprises an optical guide core, an optical cladding independent of the core, and at least two elementary zones of interaction arranged in series, each of said at least two elementary zones of interaction including a structural parameter that is different from a structural parameter of an adjacent elementary zone of interaction, each of said at least two elementary zones of interaction including an elementary grating configured to couple modes between the guide core and the optical cladding,
wherein said refractive index is modified such that at least in part of the optical cladding next to the optical guide core and at least in the zone of interaction, a refractive index of the optical cladding is different from the refractive index of the substrate and lower than a refractive index of the core, and
wherein a grating including elementary gratings of the filtering unit is created by a modification of the effective index of the substrate.

19. The method of claim 18, wherein said modifying includes irradiating said substrate and/or exposing said substrate to of ionic species

20. The method of claim 19, wherein said modifying comprises:
a) exposing the substrate to a first ionic species,
b) exposing the substrate to a second ionic species,
c) burying said first and second ionic species so as to obtain the cladding and the guide core,
d) forming the grating.

21. The method of claim 20, wherein the first and/or the second ionic species are introduced by an ionic exchange or by ionic implantation.

22. The method of claim 20, wherein the substrate includes glass and contains Na⁺ ions, the first and the second ionic species including Ag⁺ and/or K⁺ ions.

23. The method of claim 20, further comprising:
defining a first mask on said substrate prior to exposing the substrate to the first ionic species, the first mask comprising a pattern configured to define the cladding, the first ionic species being introduced through said first mask
removing the first mask, and
defining a second mask on said substrate after removing said first mask and prior to exposing said substrate to said second ionic species, said second mask comprising a pattern configured to define the core, the second ionic species being introduced through said second mask.

24. The method of claim 20, further comprising defining a mask comprising a pattern configured to define the cladding and the core, the first and second ionic species being introduced through said mask.

25. The method of claim 18, wherein the grating is formed during exposure of the substrate to ionic species though a mask defining the core and/or the cladding, or formed with a specific mask.

26. The method of claim 18, wherein the grating is obtained by local heating.

27. The method of claim 18, wherein the grating is obtained by etching of the substrate next to the zones of interaction.

28. The method of claim 20, further comprising partially burying the first ionic species before exposing the substrate to the second ionic species and burying the first and second ionic species after exposing the substrate to the second ionic species.

29. The method of claim 20, further comprising burying the first ionic species and the second ionic species after exposing the substrate to the second ionic species.

30. The method of claim 20, wherein at least part of the burying comprises applying an electrical field to the substrate.

31. The method of claim 20, wherein at least part of the burying comprises re-diffusing the first and second ionic species in an ionic bath.

32. The method of claim 20, wherein the burying includes depositing a layer on the surface of the substrate.

33. The method of claim 20, wherein the first ionic species and/or the second ionic species are introduced with the application of an electrical field.
